(19) United States
(12) Patent Application Publication
(10) Pub. No.: US 2009/0009276 A1
(43) Pub. Date: Jan. 8, 2009

(54) TRANSFORMER MOUNTED ON CIRCUIT BOARD WITH MAIN BODY SURROUNDED BY INSULATING COVER

(75) Inventor: Toshihiko JIDAISHO, Saitama (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: TAMURA CORPORATION, Tokyo (JP)

(21) Appl. No.: 12/164,409

(22) Filed: Jun. 30, 2008

(30) Foreign Application Priority Data
Jul. 4, 2007 (JP) P2007-176772

(51) Int. Cl. H01F 27/02

(52) U.S. Cl. 336/90

(57) ABSTRACT

A transformer 100 includes: a bobbin 102 around which a first winding 104 and a secondary winding 106 are wound; cores 108 attached to the bobbin 102; and a cover 114 attached to the main body 110. The cover 114 surrounds a lower surface and an upper surface in addition to side surfaces to exhibit an insulating property on a circuit board. The cover 114 is laterally attached to the main body 110 from a secondary-side direction of the main body 110, where primary and secondary sides are directions defined when the main body 110 is mounted on the circuit board.

### BACKGROUND OF THE INVENTION

1. Field of the Invention

The present invention relates to a transformer, and more particularly to a transformer having a structure suitable for being mounted on a circuit board on which other electronic components are mounted with high density.

2. Description of the Related Art

Generally, a transformer is composed of a bobbin around which a primary winding and a secondary winding are wound and an E-E core or an E-I core combined with the bobbin. Several pins project from a bottom of the bobbin, and a lead of each of the windings is soldered to one of the pins. Some of the pins are dummy pins and the windings are not soldered to the dummy pins. The transformer is fixed to a circuit board with these pins inserted in through holes of the circuit board and soldered to wiring patterns.

When the transformer is in use, there occurs a potential difference between a circuit connected to the primary winding and a circuit connected to the secondary winding. The windings are only magnetically coupled to one another via the core, and the primary-side circuit and the secondary-side circuit are electrically insulated from each other. Therefore, considering safety, a certain distance is necessary between the transformer and surrounding electric elements (electronic components, conductors, and the like) on the circuit board in order to ensure the insulation therebetween. However, when the downsizing of the whole circuit board is required, the electronic components including the transformer have to be mounted on the circuit board with high density. This limits the distance for insulation that can be reserved around the transformer on the substrate.

### SUMMARY OF THE INVENTION

The present invention disclosed and claimed herein, in one aspect thereof, comprises a transformer. This transformer adopts a structure in which its main body is surrounded by an insulating cover. The main body includes a first winding and a second winding as well as a core, and this main body is mounted between a primary-side voltage input element and a secondary-side voltage output element which are provided on a circuit board. In this state, the main body transforms an input voltage which is applied to the first winding from the voltage input element provided on the circuit board, and outputs the transformed voltage from the secondary winding to the voltage output element. The whole cover is in a box shape, and in the cover, at least a primary-side surface which faces the voltage input element in a state where the main body of the transformer is mounted on the circuit board is an opening, and the cover surrounds a secondary-side periphery including a lower surface and an upper surface of the main body mounted on the circuit board by having the main body inserted and housed in an inner chamber of the cover through the opening, with a secondary-side surface of the main body, which faces the voltage input element, being inserted first.

Further scope of applicability of the present invention will become apparent from the detailed description given hereinafter. The detailed description and embodiments are only given as examples though showing preferred embodiments of the present invention, and therefore, from the contents of the following detailed description, changes and modifications of various kinds within the spirits and scope of the invention will become apparent to those skilled in the art.

### BRIEF DESCRIPTION OF THE DRAWINGS

The present invention will be fully understood from the following detailed description and the accompanying drawings. The accompanying drawings only show examples and are not intended to restrict the present invention. In the accompanying drawings:

FIG. 1 is a perspective view showing a transformer of a first embodiment disassembled into constituent elements;

FIG. 2 is a perspective view showing a state where a primary-side direction of a main body of the transformer is set diagonally lower leftward;

FIG. 3 is a perspective view showing a state where a secondary-side direction of the main body is set diagonally lower leftward contrary to FIG. 2;

FIG. 4 is a perspective view showing an example of another form of a cover;

FIG. 5 is a perspective view showing an example of still another form of the cover different from that in FIG. 4;

FIG. 6 is a perspective view showing a transformer of a second embodiment disassembled into constituent elements;

FIG. 7 is a perspective view showing a state where a primary-side direction of a main body 110 is set diagonally lower leftward, similarly to FIG. 6;

FIG. 8 is a perspective view showing a state where a secondary-side direction of the main body 110 is set diagonally lower leftward, contrary to FIG. 7;

FIG. 9 is a perspective view showing an example where another form of the cover is applied to the second embodiment; and

FIG. 10 is a perspective view showing an example of still another form of the cover different from that in FIG. 9.

### DETAILED DESCRIPTION

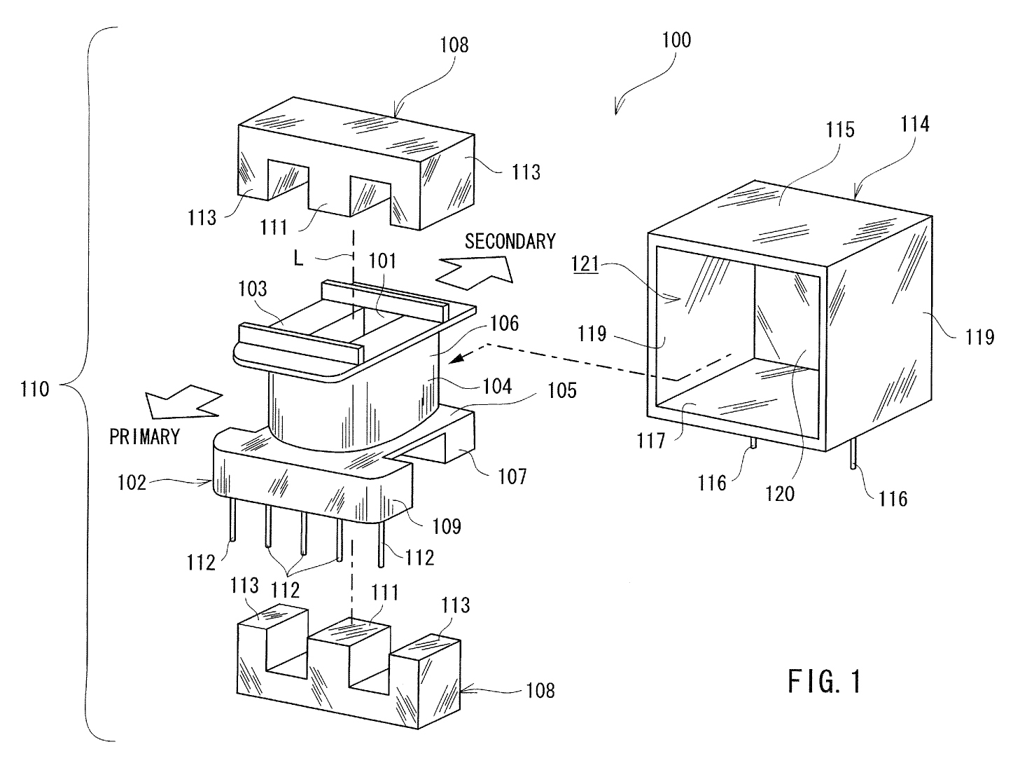

FIG. 1 shows a transformer 100 of a first embodiment disassembled into constituent elements. For example, the transformer 100 is mounted on a mounting surface of a circuit board, not shown, in an upright posture.

The transformer 100 includes a bobbin 102 made of, for example, resin. On an outer periphery of the bobbin 102, a primary winding 104 and a secondary winding 106 are wound around an axis L vertical to the circuit board. In FIG. 1, the primary winding 104 and the secondary winding 106 are both covered by an insulating material (for example, a tape) and they are not discriminately shown (the same applies hereinafter).

In the bobbin 102, a through hole 101 is vertically formed along the axis L. In the through hole 101, center legs 111 of E-cores 108 are inserted from its upper and lower ends respectively. The bobbin 102 has an upper flange 103 and a lower flange 105 in its upper and lower end portions. The upper and lower cores 108 are attached to the bobbin 102 so as to be in close contact with the upper flange 103 and the lower flange 105 respectively. When the upper and lower cores 108 are attached to the bobbin 102, the center legs 111 of these cores 108 approach each other in the through hole 101. Further, side legs 113 of the cores 108 approach each other outside the primary winding 104 and the secondary winding 106. In this state, the upper and lower cores 108 form a magnetic path. Here, the EE-core (two E-cores 108) is taken as an example, but the core of the transformer 100 may be in any other form (for example, an EI-core).

The bobbin 102 with the primary winding 104 and the secondary winding 106 wound therearound and the pair of upper and lower cores 108 attached to the bobbin 102 form a main body 110. The main body 110 is mounted on a mounting surface of the circuit board not shown. At this time, the directions of the main body 110 on the circuit board are defined as a primary side and a secondary side. In the state shown in FIG. 1, the diagonally lower left side is the primary-side direction and the diagonally upper right side is the secondary-side direction of the main body 110 as shown by the arrows in FIG. 1.

Specifically, on the circuit board on which the main body 110 is mounted, for example, wiring patterns connected to the primary winding 104 and the secondary winding 106 respectively are formed, and in addition, various kinds of electronic components (elements such as coils, resistors, capacitors, diodes, and transistors) which are connected to the primary winding 104 or the secondary winding 106 to form electric circuits are mounted. Among these wiring patterns and various kinds of the electronic components, those for applying an input voltage to the primary winding 104 can be defined as primary-side voltage input elements and those for taking out an output voltage from the secondary winding 106 can be defined as secondary-side voltage output elements. When the main body 110 is mounted on the circuit board, its primary-side surface faces the aforesaid voltage input elements and its secondary-side surface faces the aforesaid secondary voltage output elements.

The lower flange 105 of the bobbin 102 has legs 109, 107 in its primary-side portion and secondary-side portion respectively. A plurality of pin terminals 112 (primary side) protruding downward are attached to the primary-side leg 109. These pin terminals 112 are inserted in through holes of the circuit board when the main body 110 is mounted on the circuit board.

The transformer 100 includes an insulating cover 114 housing the main body 110. The cover 114 is made of insulative synthetic resin, for instance. The cover 114 has a hollow rectangular-parallelepiped shape (that is, a box shape) with one side surface thereof open. Specifically, the cover 114 has a top plate 115 and a bottom plate 117 which face each other, being apart from each other in the up/down direction. The cover 114 further has side plates 119 which face each other, being apart from each other in the horizontal direction. The cover 114 further has a wall plate 120 opposite the opening of the one side surface. The cover 114 has a chamber 121 inside. The chamber 121 has a size large enough to house most part of the main body 110.

As shown by the chain-line arrow in FIG. 1, the cover 114 is laterally (direction along the mounting surface of the circuit board) attached to the main body 110 from the secondary-side direction of the main body 110. That is, the main body 110 is laterally inserted relatively into the chamber 121 of the cover 114, with its secondary-side portion being inserted first.

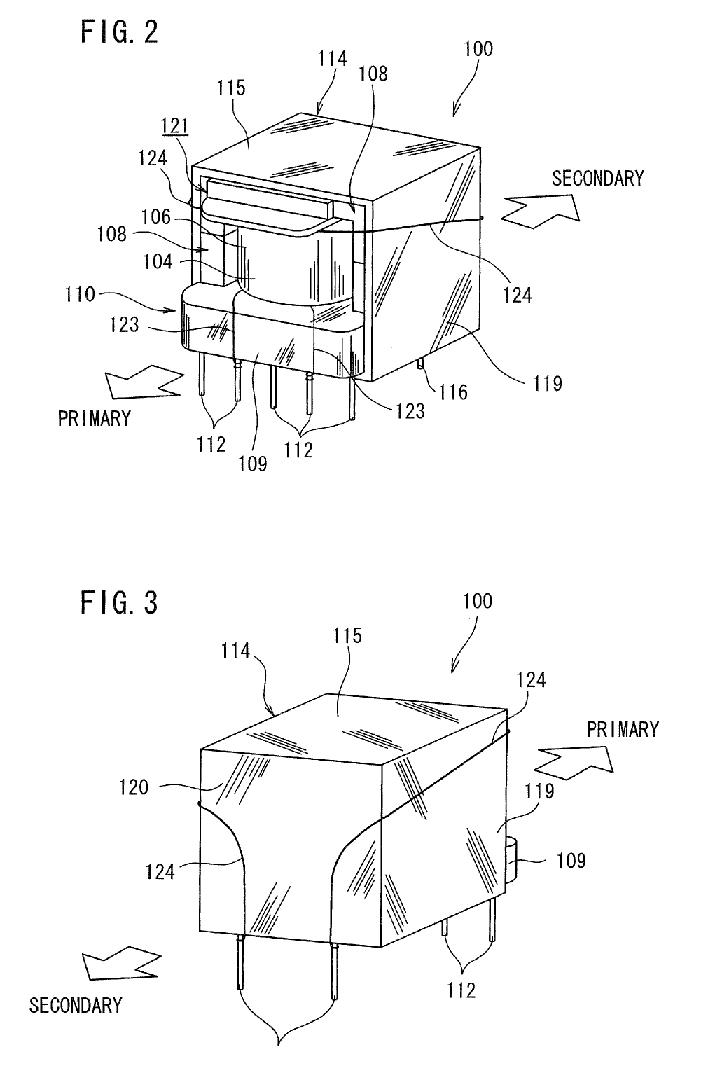

FIG. 2 and FIG. 3 show the transformer 100 in an assembled state. As shown in FIG. 2, in the state where the cover 114 is attached to the main body 110, only a primary-side outer surface (one side surface) of the main body 110 is exposed through the opening of the cover 114. At this time, all the elements of the main body 110 including the primary winding 104, the secondary winding 106, and the cores 108 are housed in the cover 114 (in the chamber 121), and these elements are surrounded by the cover 114.

Specifically, the pair of cores 108 in the combined state surrounds the whole outer periphery of the bobbin 102 (the primary winding 104 and the secondary winding 106), and four outer surfaces thereof in terms of the circumferential direction are surrounded by the top plate 115, the bottom plate 117, and the two side plates 119 of the cover 114. Further, as the whole main body 110, the secondary-side side surface is covered by the wall plate 120, and therefore, portions, of the primary winding 104 and the secondary winding 106, facing the secondary-side direction of the main body 110 are covered by the wall plate 120. Thus, the secondary-side periphery (five directions) of the main body 110 including a lower surface and an upper surface except the primary-side outer surface are surrounded by the cover 114.

Further, the primary-side leg 109 protrudes outward from the opening of the cover 114, which enables the insertion and mounting of the pin terminals 112 when the main body 110 is mounted on the circuit board. From a winding start and a winding end of the primary winding 104, leads 123 are led out respectively, and these leads 123 are fixed (for example, soldered) to the pin terminals 112 while entwining the pin terminals 112 respectively. In the leg 109, vertical grooves, not shown, for guiding the leads 123 may be formed. The secondary-side leg 107 is not shown here since it is housed in the cover 114.

As shown in FIG. 3, leads 124 are led out as well from a winding start and a winding end of the secondary winding 106 respectively. After led out from the primary-side portion of the main body 110 through the opening of the cover 114, the leads 124 are bent and extend in the secondary-side direction along the side surfaces (side plates 119) of the cover 114 respectively. After further bent along the wall plate 120, the leads 124 extend downward.

Two pin terminals 116 (secondary side) protruding downward from the bottom plate 117 are attached to the cover 114. The leads 124 are fixed (soldered) to the pin terminals 116 while entwining the pin terminals 116 respectively. In the state where the main body 110 together with the cover 114 is mounted on the circuit board, the pin terminals 116 are also inserted in through holes. Then, the pin terminals 116 are connected to the aforesaid voltage output elements (wiring patterns) by soldering.

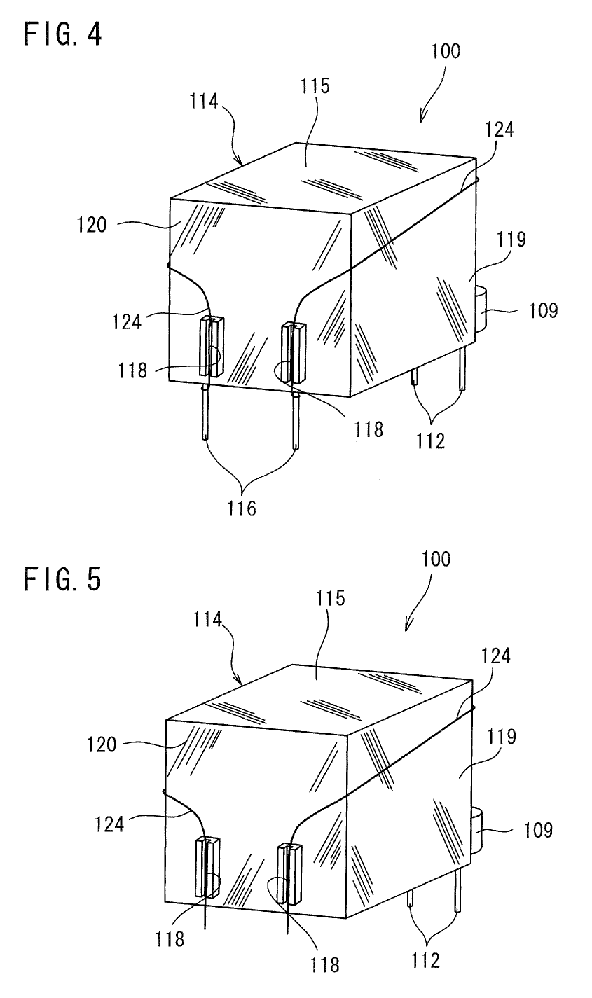

FIG. 4 and FIG. 5 are perspective views showing different examples of other forms of the cover 114. Hereinafter, these examples will be described.

In the form shown in FIG. 4, the wall plate 120 additionally has two streaks of guide grooves 118. For example, the guide grooves 118 are embossed on a surface of the wall plate 120. Concretely, portions corresponding to both sides of the guide groves 118 in the wall plate 120 are embossed, and in the embossed portions, the indented guide grooves 118 extending in the up/down direction are formed.

By burying the leads 124 in the guide grooves 118, it is possible to fix the leads 124 to the cover 114. Further, fixing the leads 124 in the guide grooves 118 can facilitate a work of entwining the leads 124 around the pin terminals 116.

In the form shown in FIG. 5, two streaks of guide grooves 118 are formed in the wall plate 120 and the aforesaid pin terminals 116 are not provided. The guide grooves 118 are the same as those described above. Even with such a form, it is possible to fix tip portions of the leads 124 to the cover 114, which can facilitate the insertion and mounting of the leads 124 when the main body 110 together with the cover 114 is mounted on the circuit board.

According to the transformer 100 of the first embodiment described above, at the time of its assembly, only by laterally attaching the single cover 114 from the secondary-side direction of the main body 110 and inserting and assembling the main body 110 in the cover 114, the cover 114 can surround the whole periphery of the main body 110 including its upper and lower surfaces except the primary-side surface.

Further, according to the transformer 100 of the first embodiment, in the state where the main body 110 is mounted on the circuit board, its secondary-side periphery facing the voltage output elements is surrounded by the cover 114. This can ensure the insulation of the main body 110 from the voltage output elements (including elements such as the wiring patterns, coils, resistors, capacitors, diodes, and transistors) provided on the circuit board, which allows a reduction in the distance from the periphery of the main body 110 to the wring patterns and electronic components which are the voltage output elements, compared with a case where the main body 110 is not surrounded and thus is exposed. Therefore, the whole transformer 100 can meet the demand for high-density mounting on the circuit board.

In particular, in the first embodiment, not only the side surfaces (three directions except the primary-side direction) of the main body 110 but also the periphery including the upper surface and the lower surface (five directions) can be surrounded only by the single cover 114. This eliminates a need for preparing a plurality of components as the cover 114 and separately assembling these components to the main body 110. Further, in the first embodiment, the assembly is completed only with a simple work of laterally inserting the main body 110 into the cover 114 with its secondary-side portion being inserted first, which accordingly reduces the trouble of the mounting work. Therefore, it is possible to improve production efficiency of an electronic device or the like in which the transformer 100 is assembled.

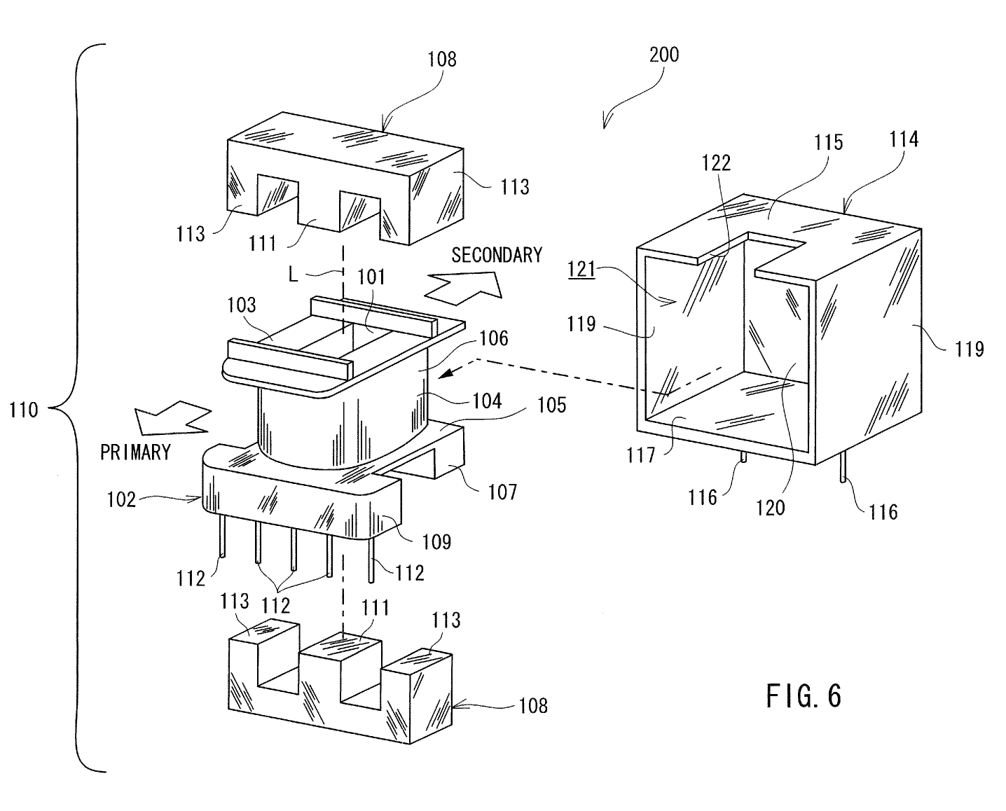

Next, a transformer 200 of a second embodiment will be described. FIG. 6 shows the transformer 200 of the second embodiment disassembled into constituent elements. The form of the cover 114 is what makes the transformer 200 of the second embodiment different from the first embodiment. The other structure is the same as that of the first embodiment, and therefore, only portions characterizing the second embodiment will be hereinafter described. Portions common to the first embodiment will be denoted by the same reference numerals and symbols as those used in the first embodiment, and redundant description thereof will be omitted.

The second embodiment is different from the first embodiment in that a cut, namely, a sub-opening 122, is formed in a top plate 115 of a cover 114. Such a sub-opening 122 exposes part of an upper surface of a main body 110 which is housed in the cover 114. Hereinafter, concrete description will be given with reference to the drawings.

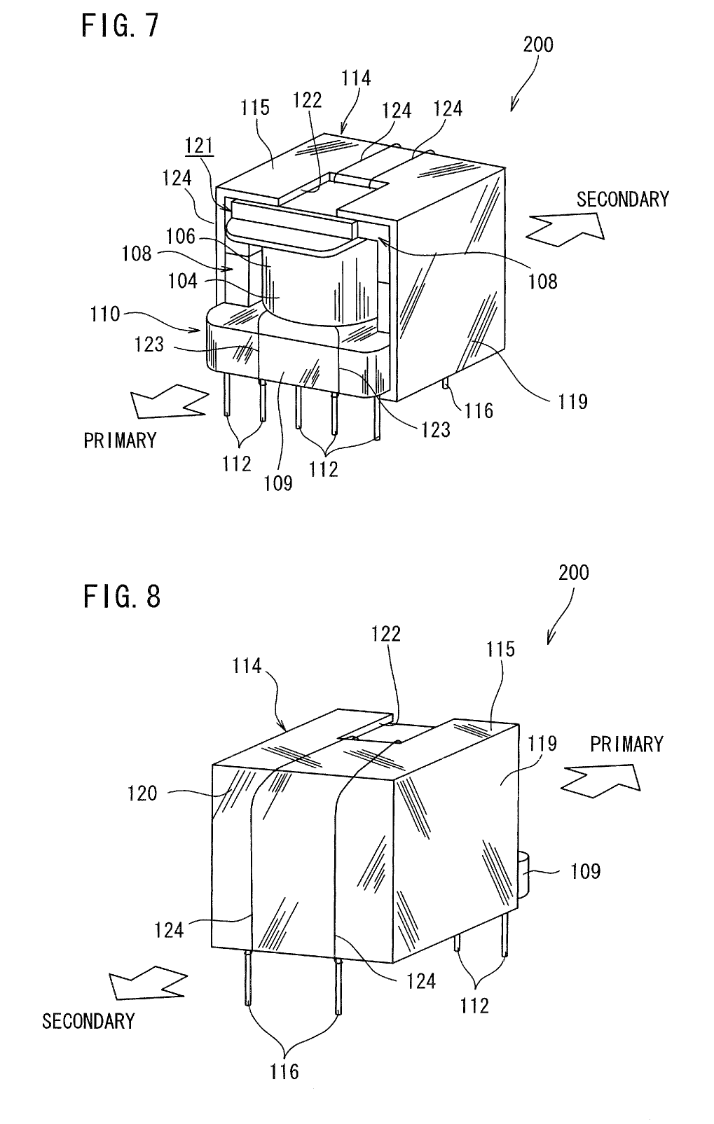

As shown in FIG. 7, firstly, a primary-side surface (one side surface) of the main body 110 is exposed through an opening of the cover 114 in a state where the cover 114 is attached to the main body 110. In addition, in the second embodiment, an upper core 108 is partly exposed in the sub-opening 122. Leads 124 of a secondary winding 106 are led out in a secondary-side direction through the sub-opening 122 from the upper surface side of the main body 110.

As shown in FIG. 8, in the secondary-side portion of the main body 110, the leads 124 extending from the sub-opening 122 directly extend in the secondary-side direction of the main body 110 and are then bent downward along a wall plate 120. In this case, since the leads 124 do not have to be led through the primary-side opening and led around a long distance along the side plates 119 while being bent in the secondary-side direction as is done in the first embodiment (see FIG. 3), a work of leading around the leads 124 is further facilitated. Further, when the leads 124 are led around from a secondary winding 106 to the pin terminals 116, the route with the substantially the shortest distance is taken, which prevents the leads 124 from dangling on surfaces of a top plate 115 and the wall plate 120 and thus can keep the leads 124 stable.

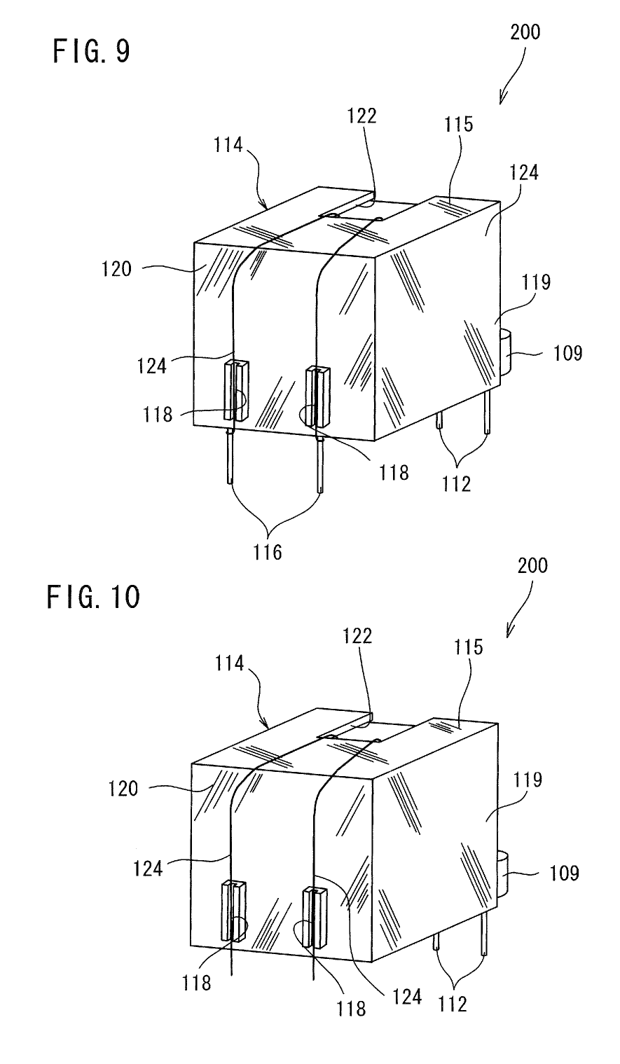

For fixing the leads 124, the same structures as those in the first embodiment are adoptable in the second embodiment as well. FIG. 9 shows an example where two streaks of guide grooves 118 are additionally formed in the wall plate 120 of the cover 114 in the second embodiment. In the second embodiment, the leads 124 can be led substantially straight from a top portion of the wall plate 120 toward the guide grooves 118, which can further facilitate the work of inserting the leads 124 in the guide grooves 118.

As shown in FIG. 10, also in the second embodiment, the structure is adoptable in which two streaks of the guide grooves 118 are formed in the wall plate 120 of the cover 114 and the pin terminals 116 are not provided. In this case, since the leads 124 can be similarly led substantially straight from the top portion of the wall plate 120 toward the guide grooves 118, the work of inserting the leads 124 in the guide grooves 118 is further facilitated.

According to the second embodiment, when the main body 110 is inserted into the cover 114 in the assembly work, the leads 124 connected to the secondary winding 106 can be led out from the sub-opening 122 to be directly led in the secondary-side direction, which further facilitates the work of entwining the leads 124 around the pin terminals 116 and burying the leads 124 in the guide grooves 118. Further, even though the sub-opening 122 is formed in the top plate 115 of the cover 114, the upper core 108 except its portion corresponding to the sub-opening 122 is covered by the cover 114, which accordingly allows a reduction in the distance from the voltage output elements.

Since the upper side (upper surface) of the main body 110 is covered by the cover 114 in the embodiments described above, the main body 110 can be mounted with a reduced distance from the other voltage output elements (capacitors and so on) in terms of the height direction on the circuit board, which can accordingly contribute to higher-density mounting on the circuit board. In addition, since the whole cover 114 is only a single component, a complicated work of assembling two components or more to the main body 110 is not necessary, which accordingly can improve work efficiency.

According to the embodiments described above, the insulation between the main body 110 and the secondary-side voltage output elements is ensured on the circuit board, which can easily realize the high-density mounting. Especially because the main body 110 is inserted into the cover 114, with its secondary-side portion being inserted first, the insulation of the secondary-side portion of the transformer 100 is ensured. Further, since the cover 114 is a single component, the assembly work of the transformer 100 is easy, which can accordingly improve productivity.

The shape of the cover 114 is not limited to a simple hollow pentahedral shape but may be any other three-dimensional shape. Further, the shape, size, length, and so on of the guide grooves 118 can be arbitrarily changed. Grooves other than the guide grooves 118, projections or the like may be provided on an outer surface of the cover 114 to have the leads 124 hooked thereto.

Further, the structures described in the embodiments with reference to the drawings are only preferable examples. Various elements may be added to the basic structures of the embodiments, or part of the elements may be replaced.

What is claimed is:

1. A transformer comprising:
a main body mounted between a primary-side voltage input element and a secondary-side voltage output element which are provided on a circuit board, transforming an input voltage applied to a primary winding from the voltage input element, and outputting the transformed voltage from a secondary winding to the voltage output element; and
a cover at least whose primary-side surface facing the voltage input element in a state where said main body is mounted on the circuit board is an opening, and which surrounds a secondary-side periphery including a lower surface and an upper surface of said main body mounted on the circuit board by having said main body inserted and housed in an inner chamber of said cover through the opening, with a secondary-side surface of the main body, which faces the voltage output element, being inserted first.

2. The transformer according to claim 1, wherein
said cover fixes a lead to the cover itself in a state where the main body is housed in the cover, the lead being led out through the opening from the secondary winding.

3. The transformer according to claim 2, wherein
said cover has a pin terminal facing a mounting surface of the circuit board to protrude downward from said cover and fixing the lead by having the lead entwined therearound.

4. The transformer according to claim 2, wherein
said cover has a guide groove guiding the lead along an outer surface of said cover and fixing the lead by having the lead buried therein.

5. The transformer according to claim 2, wherein
said cover has:
a pin terminal facing a mounting surface of the circuit board to protrude downward from said cover and fixing the lead by having the lead entwined therearound; and
a guide groove guiding the lead along an outer surface of said cover and fixing the lead by having the lead buried therein.

6. The transformer according to claim 1 wherein:
said cover has a sub-opening which exposes part of a top surface of said main body in the state where said main body is mounted on the circuit board; and
in the state where said main body is housed in said cover, the lead led out through the sub-opening from the secondary winding is fixed to said cover.

7. The transformer according to claim 6, wherein
said cover has a pin terminal facing a mounting surface of the circuit board to protrude downward from said cover and fixing the lead by having the lead entwined therearound.

8. The transformer according to claim 6, wherein
said cover has a guide groove guiding the lead along an outer surface of said cover and fixing the lead by having the lead buried therein.

9. The transformer according to claim 6, wherein
said cover has:
a pin terminal facing a mounting surface of the circuit board to protrude downward from said cover and fixing the lead by having the lead entwined therearound; and
a guide groove guiding the lead along an outer surface of said cover and fixing the lead by having the lead buried therein.
